(19) United States
(12) Patent Application Publication
(10) Pub. No.: US 2009/0166595 A1
(43) Pub. Date: Jul. 2, 2009

(54) ENHANCED CHEMILUMINESCENT LIGHTING FORMULATION AND ELEMENT

(75) Inventors: Michael L. Schrimmer, Vernon Hills, IL (US); Ronald E. Gilley, Winnetka, IL (US); John Friedson, Longmeadow, MA (US)

Correspondence Address: Levenfeld Pearlstein, LLC;Intellectual Property Department, 2 North LaSalle, Suite 1300, Chicago, IL, 60602, US

(73) Assignee: CHEMICAL LIGHT, INC., Vernon Hills, IL (US)

(21) Appl. No.: 12/133,127

(22) Filed: Jun. 4, 2008

Related U.S. Application Data
(60) Provisional application No. 60/953,401, filed on Aug. 1, 2007.

(51) Int. Cl. C09K 11/07

(52) U.S. Cl. 252/700

(57) ABSTRACT

A chemiluminescent formulation includes an oxalate solution including a dye and an activator solution including polyethylene oxide. The oxalate solution and the activator solution are mixed to form a chemiluminescent mixture. Chemiluminescent energy in the form of light is emitted after mixing. The polyethylene oxide substantially increases the light output from the chemiluminescent mixture compared to a non-polyethylene oxide containing formulation.

### BACKGROUND OF THE INVENTION

The present invention is directed to a chemiluminescent lighting formulation and element. More specifically, the present invention is directed to a time and luminosity enhanced chemiluminescent formulation and element.

Chemiluminescent elements also known as light sticks are in widespread use. From childrens' toys and novelty items to emergency and warning devices, these compact, on-demand, weather-proof products, often referred to as “light sticks” are available in all manner of sizes and designed for all manner of uses.

In chemiluminescence, it is the mixture of two or more components that react to emit light. Typically, one of the components is contained within a larger, flexible plastic tube and the other of the components is contained within a frangible (typically glass) vial within the plastic tube. The tube is bent to break the glass vial and the two components are mixed to create the mixture that creates the chemiluminescence.

Until the late 1990s, chemical light was made using what the industry calls ‘normal chemistry’ formulations. In normal chemistry, one of the components (an activator) is formulated with dimethyl phthalate with hydrogen peroxide, a salt such as sodium salicylate to act as a catalyst, and some tertiarybutyl alcohol to help keep the peroxide in solution. The other component (an oxalate) typically includes bis(2,4,5-trichlorophenyl-6-carbopentoxyphenyl)oxalate (CPPO) in dibutyl phthalate with a dye, such as rubrene. Rubrene (1-chloro-9,10-bis(phenylethynyl)anthracene) is a known orange fluorescent dye.

In normal chemistry systems, oxalate to activator ratios are typically skewed towards much larger quantities of oxalate, since only about 11% CPPO can be solvated in dibutyl phthalate. As such, in a light stick where you have a tube with one solution in a glass vial, the only practical way to get a 3:1 oxalate:activator ratio is to put the activator in the glass vial, with the oxalate outside the vial in the plastic tube.

One drawback to normal chemistry is that the CPPO (in the oxalate) is hygroscopic, and the presence of water, over time, diminishes that ability of the CPPO to properly function and degrades or renders the light stick non-functional. Activator components, on the other hand typically contain water as a diluent for the hydrogen peroxide, and are not hurt by the presence of water. Since water vapor can permeate through the plastic sidewalls of a light stick over time, and since the oxalate is in the plastic tube, normal chemistry sticks require much attention and special foil packaging to insure good shelf life.

The identification of new solvents, particularly butyl benzoate, which has been found to solvate about twice as much CPPO compared to dibutyl phthalate, enabled “reverse chemistry” in which the concentrated oxalate formula, with as much as 26% CPPO, could be present in the glass vial. In this arrangement, the CPPO was now isolated from water in that it was protected by glass. This eliminated the need for special foils which in turn reduced package sealing and handling requirements. Accordingly, the majority of today's manufacturers use butyl benzoate as the oxalate solvent in reverse chemistry formulations, and dibutyl phthalate is no longer the solvent of choice.

Of the dyes used to “color” the light from light sticks, rubrene ((5,6,11,12-tetraphenylnaphthacene) is a red colored polycyclic aromatic hydrocarbon that is particularly valuable as its light output is an unusual color, orange, and the light intensity from it is very high, compared to other alternatives, particularly in the orange/red alternatives. Although other red and orange dyes are available that work with reverse chemistry systems, their light output is characteristically very low compared to those available in yellow, yellow green, and green families. However, rubrene in the reaction mixture is typically short lived. Accordingly, rubrene is commonly used in sticks of less than one hour duration. The reaction has to be “buffered” to enable it to survive longer. Work has been done in normal chemistry systems to try to extend the light output of rubrene.

Accordingly, there is a need for a time and luminosity enhanced chemiluminescent formulation and element. Desirably, such a formulation and element permit the use of known dyes (rubrene) to provide a high output light stick that has a prolonged activated life. More desirably, such a light stick has a long shelf life and does not require special packaging and/or handling requirements.

### BRIEF SUMMARY OF THE INVENTION

A chemiluminescent formulation includes an oxalate solution including a dye and an activator solution including polyethylene oxide. When the oxalate solution and the activator solution are mixed to form a chemiluminescent mixture, chemiluminescent energy in the form of light is emitted. The polyethylene oxide substantially increases the light output from the chemiluminescent mixture compared to a non-polyethylene oxide containing formulation.

The light output from the chemiluminescent mixture is increased by at least about a factor of 2 over a period of at least about 8 hours. In a present formulation the oxalate solution and the activator solution are present in a ratio of about 4.4:5.7.

The dye can be rubrene and the oxalate solution can be butyl benzoate, CPPO with an effective amount of the dye.

In a present formulation, the butyl benzoate is present in a concentration of about 87.4 percent by weight, the CPPO is present in a concentration of about 12.0 percent by weight and the dye is present in a concentration of about 0.60 percent by weight.

The activator solution can be is dimethyl phthalate, a salt and polyethylene oxide, present in a concentration of about 74.8 percent by weight, with the salt present in a concentration of about 0.25 percent by weight and the polyethylene oxide present in a concentration of about 0.20 percent by weight.

A chemiluminescent light stick is disclosed that includes the present chemiluminescent formulation. The light stick preferably includes an outer flexible element and a frangible container disposed within the outer flexible element, in which the oxalate solution is disposed in the frangible container and the activator solution is disposed in the outer flexible element.

These and other features and advantages of the present invention will be apparent from the following detailed description, in conjunction with the appended claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is a perspective view of a light element or stick having an enhanced chemiluminescent lighting formulation contained therein.

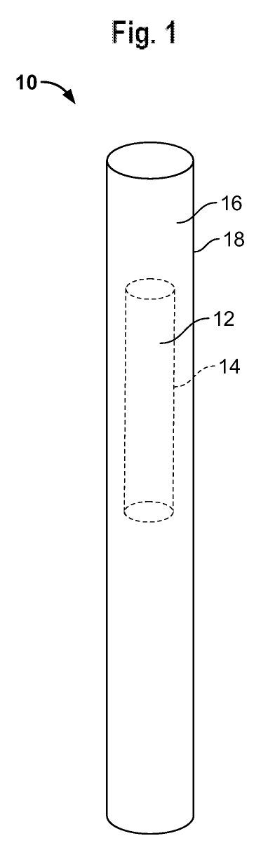

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description Of The Invention”, relates to a requirement of the United States Patent Office, and does not imply, nor should be inferred to limit the subject matter disclosed herein.

A present chemiluminescent formulation provides a time and luminosity enhanced chemiluminescent formulation and element. A present formulation and element permit the use of rubrene to provide a high output red/orange light element 10 (light stick) that has a prolonged activated life. The light stick has a long shelf life and does not require special packaging and/or handling requirements.

A present formulation is of the reverse chemistry type. That is, the oxalate (as indicated at 12) is present in the vial 14 and the activator (as indicated at 16) is present in the plastic tube 18. In this configuration, the butyl benzoate-based oxalate includes CPPO and an effective amount of rubrene. In a present formulation, the oxalate includes butyl benzoate (about 87.4 percent by weight), having 12 percent by weight CPPO and 0.60 percent by weight rubrene.

The activator solution is a dimethyl phthalate based activator (about 74.8 percent by weight), having about 0.25 percent by weight sodium salicylate, and about 0.20 percent by weight of a polymer, polyethylene oxide with a molecular weight of about 200,000 (commercially available from Dow Chemical Company of Midland, Mich.). Other suitable catalysts, such as lithium salicylate can also be used.

The oxalate is present at a weight of 4.4 gms. and the activator is present at a weight of 5.7 gms., and as such the oxalate is present in an overall concentration of about 44 percent by weight.

It has been found that polyethylene oxide in the chemiluminescent formulation increases the light output of these systems. However, in an attempt to create a reverse chemistry polyethylene enhanced chemiluminescent system, it was found that, using rubrene as the dye, a sufficient amount of polyethylene oxide could not be kept in the oxalate solution.

To provide the enhanced effect to the polyethylene oxide it was found that incorporating the polyethylene oxide in the dimethyl phthalate based activator solution with the rubrene dye present in the oxalate solution achieves the desired enhanced light output while maintaining an effective amount of polyethylene oxide, and at the same time, encapsulating the CPPO in the sealed glass vial to prevent the CPPO from degradation due to exposure to water.

It will be appreciated that it may not be ‘more’ in terms of total light, because with rubrene, for example, you get a great deal of light very quickly without the use of polyethylene oxide. However, that light is released too quickly and therefore the utility of the stick is reduced. With the present formulation, the light is not only more intense than other non-high intensity orange sticks, it is also much better distributed for general use than high-intensity sticks.

Samples of a light stick made in accordance with the present formulation were compared to known, commercially available light sticks to determine the light output over time for the two products. Two samples of each the commercially available light stick and a light stick in accordance with the present invention were compared.

TABLE 1
LIGHT OUTPUT OVER TIME FOR A PRESENT LIGHT STICK
AND A COMMERCIALLY AVAILABLE LIGHT STICK

| Type/Time | 0 Min | 15 Min | 1 Hr | 2 Hr | 3 Hr | 4 Hr | 5 Hr | 6 Hr | 7 Hr | 8 Hr |
|---|---|---|---|---|---|---|---|---|---|---|
| Comm. avail. | 164 | 8.1 | 4.35 | 2.7 | 1.9 | 1.4 | 1.09 | 0.7 | 0.51 | 0.39 |
| | 167 | 8.8 | 4.5 | 2.8 | 1.94 | 1.52 | 1.1 | 0.75 | 0.55 | 0.36 |
| Average | 165.5 | 8.45 | 4.425 | 2.75 | 1.92 | 1.46 | 1.095 | 0.725 | 0.53 | 0.375 |
| Present form. | 443 | 20.01 | 10.06 | 7.62 | 6.23 | 5.18 | 4.12 | 2.88 | 1.52 | 0.71 |
| | 389 | 18.78 | 9.87 | 7.36 | 6.17 | 4.95 | 3.73 | 2.15 | 1.1 | 0.61 |
| Average | 416 | 19.395 | 9.965 | 7.49 | 6.2 | 5.065 | 3.925 | 2.515 | 1.31 | 0.66 |

As can be seen from the results shown in Table 1, the present formulation provides significantly enhanced light output (results indicated in lux (lumens per square meter), over time compared to a commercially known (commercially available) light stick having similar color and composition. For example, at every time period, the light output in lux is at least twice as great in the present chemiluminescent formulation and light stick than in the commercially available, conventional light stick.

It is anticipated the other suitable polymers may be used instead of polyethylene oxide, such as resins of the urea-formaldehyde type, or resins based on melamine-formaldehyde, sulfonamide, glycerophthalate, vinylic, acrylic, acrylonitrile and polyester polymers.

It is also anticipated that suitable activators other than a dimethyl phthalate based activator can be used, such as triethyl citrate, and that oxalate solvents other than butyl benzoate-based oxalate, such as propylene glycol dibenzoate can be used in a present light stick formulation, and that in any case, it is anticipated that the polymer being present in the activator (as opposed to the oxalate) will function to enhance the light output of the chemiluminescent formulation.

It will also be appreciated that although use of the present polyethylene oxide formulation in activator is not limited to the exemplary rubrene dye, but is anticipated to function well with other dyes and change their light output characteristics as well.

All patents referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover all such modifications as fall within the scope of the disclosed, exemplary embodiment.

What is claimed is:

1. A chemiluminescent formulation comprising:
an oxalate solution including a dye; and
an activator solution including polyethylene oxide,
wherein when the oxalate solution and the activator solution are mixed to form a chemiluminescent mixture, chemiluminescent energy in the form of light is emitted, and wherein the polyethylene oxide substantially increases the light output from the chemiluminescent mixture compared to a non-polyethylene oxide containing formulation.

2. The chemiluminescent formulation in accordance with claim 1 wherein the light output from the chemiluminescent mixture is increased by at least about a factor of 2 over a period of at least about 8 hours.

3. The chemiluminescent formulation in accordance with claim 1 wherein the oxalate solution and the activator solution are present in a ratio of about 4.4:5.7.

4. The chemiluminescent formulation in accordance with claim 1 wherein the dye is rubrene.

5. The chemiluminescent formulation in accordance with claim 1 wherein the oxalate solution is butyl benzoate, CPPO and an effective amount of dye.

6. The chemiluminescent formulation in accordance with claim 5 wherein the butyl benzoate is present in a concentration of about 87.4 percent by weight, the CPPO is present in a concentration of about 12.0 percent by weight and the dye is present in a concentration of about 0.60 percent by weight.

7. The chemiluminescent formulation in accordance with claim 1 wherein the activator solution is dimethyl phthalate, a salt and polyethylene oxide.

8. The chemiluminescent formulation in accordance with claim 7 wherein the dimethyl phthalate is present in a concentration of about 74.8 percent by weight, the salt is present in a concentration of about 0.25 percent by weight and the polyethylene oxide is present in a concentration of about 0.20 percent by weight.

9. A chemiluminescent light stick in accordance with the formulation of claim 1.

10. The chemiluminescent light stick in accordance with claim 9 including an outer flexible element and a frangible container disposed within the outer flexible element, wherein the oxalate solution is disposed in the frangible container and the activator solution is disposed in the outer flexible element.
